(19) United States
(12) Patent Application Publication
(10) Pub. No.: US 2014/0184983 A1
(43) Pub. Date: Jul. 3, 2014

(54) LCD MODULE AND LCD DEVICE

(71) Applicant: SHENZHEN CHINA STAR OPTOELECTRONICS TECHNOLOGY CO., LTD., Shenzhen (CN)

(72) Inventors: Zexin Wu, Shenzhen (CN); Quan Li, Shenzhen (CN)

(73) Assignee: SHENZHEN CHINA STAR OPTOELECTRONICS TECHNOLOGY CO., LTD, Shenzhen (CN)

(21) Appl. No.: 13/809,479

(22) PCT Filed: Jan. 6, 2013
(86) PCT No.: PCT/CN2013/700098

§ 371 Date: Jan. 10, 2013

(30) Foreign Application Priority Data
Dec. 28, 2012 (CN) 201210586652.9

(51) Int. Cl. G02F 1/1335

(52) U.S. Cl. CPC G02F 1/133608
USPC 349/61

(57) ABSTRACT

The present disclosure provides a liquid crystal display (LCD) module and an LCD device. The LCD module includes an LCD panel and a backplane. The LCD panel is fixed to the backplane by a magnet.

### TECHNICAL FIELD

The present disclosure relates to the field of liquid crystal displays (LCDs), and more particularly to an LCD display module and an LCD device.

### BACKGROUND

As shown in FIG. 1, a typical liquid crystal display (LCD) device, such as an LCD and an LCD television, includes an LCD module. The LCD module generally includes a front frame 1, an LCD panel 4, a middle frame 2, a backlight module 5, and a backplane 3. The front frame 1, the middle frame 2, and the backplane 3 have different functions. The front frame 1 is mainly used to fix the LCD panel 4 to prevent the LCD panel 4 from falling off. The middle frame 2 is mainly used to support the LCD panel 4. The backplane 3 is mainly used to support and contain the backlight module 5. The front frame 1, the middle frame 2, and the backplane 3 are tightened by a fastener or a screw after the front frame 1, the middle frame 2, and the backplane 3 are installed, which makes the LCD module have a higher strength. However, because the sidewalls of the front frame 1, the middle frame 2 and the backplane 3 are superimposed, the LCD module has a frame, where the frame is difficult to be made narrower.

### SUMMARY

In view of the above-described problems, the aim of the present disclosure is to provide a liquid crystal display (LCD) module and an LCD device of which the LCD panel is connected with the backplane by an magnet attraction.

A first technical scheme of the present disclosure is that: an LCD module comprises an LCD panel and a backplane. The LCD panel is fixed to the backplane by a magnet. A back of the LCD panel is configured with an iron connecting piece, and the backplane is connected with the LCD panel from the back of the LCD panel. The backplane and the iron connecting piece not exceeding the edge of the LCD panel. The backplane comprises a sidewall. An upper edge of the sidewall of the backplane is configured with a horizontal wall that support the LCD panel, and the sidewall of the backplane is bent outwards to form the horizontal wall. The LCD panel is configured with an iron connecting piece, and the iron connecting piece has a U-shaped cross section with an opening facing the outward. The backplane is made of a ferromagnetic material, the magnet is arranged in the iron connecting piece, and the iron connecting piece is magnetically attracted to the horizontal wall of the backplane.

A second technical scheme of the present disclosure is that an LCD module comprises an LCD panel and a backplane. The LCD panel is fixed to the backplane by a magnet.

In one example, a back of the LCD panel is configured with a magnet or an iron connecting piece, and the backplane is connected with the LCD panel from the back of the LCD panel, the backplane, the magnet, or the iron connecting piece not exceeding an edge of the LCD panel. Thus, the LCD module has not frame at all, which solves the problem that the frame width of frames of LCD modules in the prior art are unable to be narrowed.

In one example, the backplane comprises a sidewall. An upper edge of the sidewall of the backplane is configured with a horizontal wall that supports the LCD panel.

In one example, the sidewall of the backplane is bent outwards to form the horizontal wall, or the sidewall of the backplane is bent inwards to form the horizontal wall.

In one example, the LCD panel is configured with a magnet, the backplane is made of a ferromagnetic material, and the magnet is magnetically attracted to the horizontal wall of the backplane.

In one example, the LCD panel is configured with a magnet, the horizontal wall of the backplane is fixedly configured with an iron connecting piece or a magnet, the magnet of the LCD panel is magnetically attracted to the iron connecting piece or the magnet of the horizontal wall of the backplane. When the backplane is not made of the ferromagnetic material, the magnet may not be attracted the backplane. The magnetic attraction problem is solved by arranging the iron connecting piece or the magnet on the horizontal wall of the backplane.

In one example, the LCD panel is fixedly configured with an iron connecting piece, and the iron connecting piece has a U-shaped cross section with the opening facing outwards. The backplane is made of a ferromagnetic material, the magnet is arranged in the iron connecting piece, and the iron connecting piece is magnetically attracted to the horizontal wall of the backplane. The iron connecting piece controls the distance between the LCD panel and the horizontal wall of the backplane to enable thickness of the magnet to be freer in design.

In one example, the LCD panel is configured with an iron connecting piece. The iron connecting piece has an L-shaped cross section. The iron connecting piece comprises a first wall and a second wall. The backplane comprises a sidewall. An upper surface of the first wall is connected with the LCD panel, and a lower surface of the first wall is abutted with the sidewall of the backplane. The second wall is arranged outside the sidewall of the backplane, and the magnet is arranged between and magnetically attracted to the second wall and the sidewall of the backplane. Because the second wall of the iron connecting piece is arranged outside the sidewall of the backplane, it is difficult for dust to enter into the inside of the LCD module.

In one example, the LCD panel is fixedly configured with an iron connecting piece. The iron connecting piece has an L-shaped cross section, and comprises a first wall and as second wall. The backplane comprises a sidewall. An upper surface of the first wall is connected with the LCD panel, and a lower surface of the first wall is abutted with the sidewall of the backplane. The second wall is arranged outside the sidewall of the backplane and is in contact with the sidewall of the backplane, and the magnet is arranged inside the sidewall of the backplane, to enable the second wall of the iron connecting piece to be magnetically attracted to the sidewall of the backplane. Because the magnet is arranged inside the backplane, the position of the magnet is difficult to change, and the magnet is difficult to fall off.

The present disclosure further provides a third technical scheme: an LCD device comprises the LCD module mentioned above.

Advantages of the present disclosure are summarized below: the LCD panel of the LCD module of the present disclosure is fixed to the backplane by the magnet. The structure omits the front frame and the middle frame, which makes the LCD module simple structure and installs easily, and lays a good foundation for a no frame design.

### BRIEF DESCRIPTION OF FIGURES

FIG. 1 is a structural diagram of a liquid crystal display (LCD) module in the prior art;

FIG. 2 is a structural diagram of a first example of an LCD module of the present disclosure;

FIG. 3 is a structural diagram of a second example of an LCD module of the present disclosure;

FIG. 4 is a structural diagram of a third example of an LCD module of the present disclosure;

FIG. 5 is a structural diagram of a fourth example of an LCD module of the present disclosure; and

FIG. 6 is a structural diagram of a fifth example of an LCD module of the present disclosure.

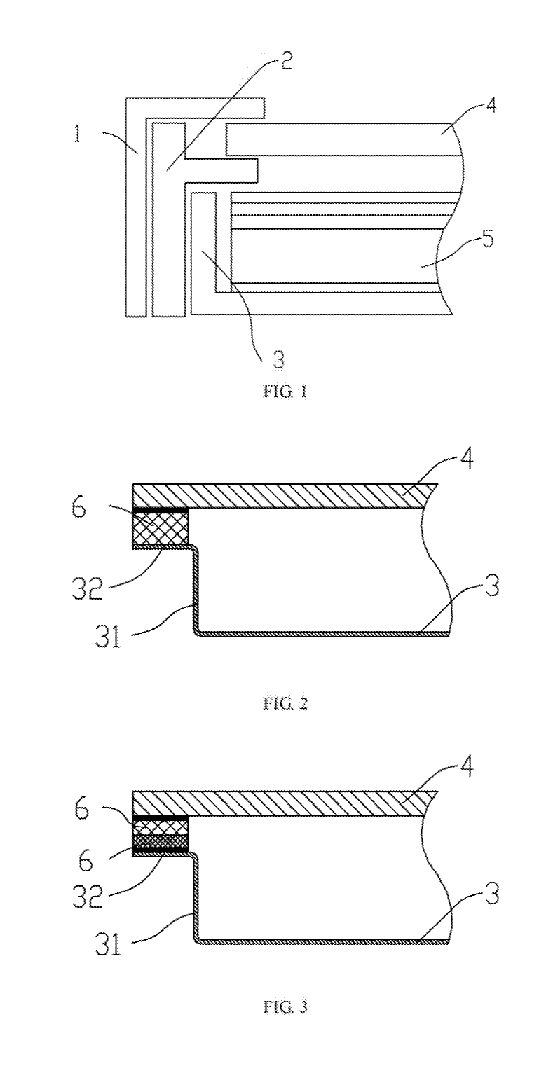

### DETAILED DESCRIPTION

The present disclosure provides a liquid crystal display (LCD) device that comprises an LCD module. FIG. 2 shows a first example of the LCD module of the present disclosure. The LCD module comprises an LCD panel 4 and a backplane 3. The LCD panel 4 is fixed to the backplane 3 by a magnet 6.

In the example, a back of the LCD panel 4 is configured with a magnet 6, and the backplane 3 is connected with the LCD panel 4 from the back of the LCD panel 4. Specifically, the magnet 6 is stuck to the LCD panel 4 by glue. The backplane 3 comprises a sidewall 31. An upper edge of the sidewall 31 of the backplane 3 is configured with a horizontal wall 32 that supports the LCD panel 4 and increases an attraction area of the magnet 6. Specifically, the sidewall 31 of the backplane 3 is bent outwards to form the horizontal wall 32, the backplane 3 is made of a ferromagnetic material, and the magnet 6 is magnetically attracted to the horizontal wall 32 of the backplane 3.

The LCD panel 4 of the LCD module of the present disclosure fixes the backplane 3 by the magnet 6. The structure omits the front frame and the middle frame, namely the front frame unpresses a front of the LCD panel 4, which makes the structure of the LCD module simple and installs easily, and lays a good foundation for a no frame design. When the LCD module needs to be disassembled during maintenance, the LCD panel 4 is disconnected from the backplane 3 by only using force that is greater than an attraction force of the magnet.

In order to prevent foreign matter, such as dust, from entering into an inside of the LCD module from a assembly gap between the LCD panel 4 and the horizontal wall 32 of the backplane 3, a sealing element is generally arranged between the LCD panel 4 and the horizontal wall 32 of the backplane 3.

In the example, because the backplane 3 and the magnet 6 not exceedings an edge of the LCD panel 4, the LCD module has no frame, which solves the problem that width of frames of LCD modules in the prior art are unable to be narrowed.

FIG. 3 shows a second example of the LCD module of the present disclosure, where the second example is different from the first example in that: when the backplane 3 is not made of the ferromagnetic material, the magnet 6 may not be attracted the backplane 3. In the example, the horizontal wall 32 of the backplane 3 is configured with a magnet 6. Specifically, the magnet 6 is stuck to the horizontal wall 32 by the glue, and the magnet 6 of the back of the LCD panel 4 is magnetically attracted to the magnet 6 of the horizontal wall 32 of the backplane.

In the example, as an alternative scheme, the horizontal wall 32 of the backplane 3 is configured with an iron connecting piece, the magnet 6 of the LCD panel is magnetically attracted to the iron connecting piece of the horizontal wall 32 of the backplane 3, or the iron connecting piece is welded to the horizontal wall 32 of the backplane 3.

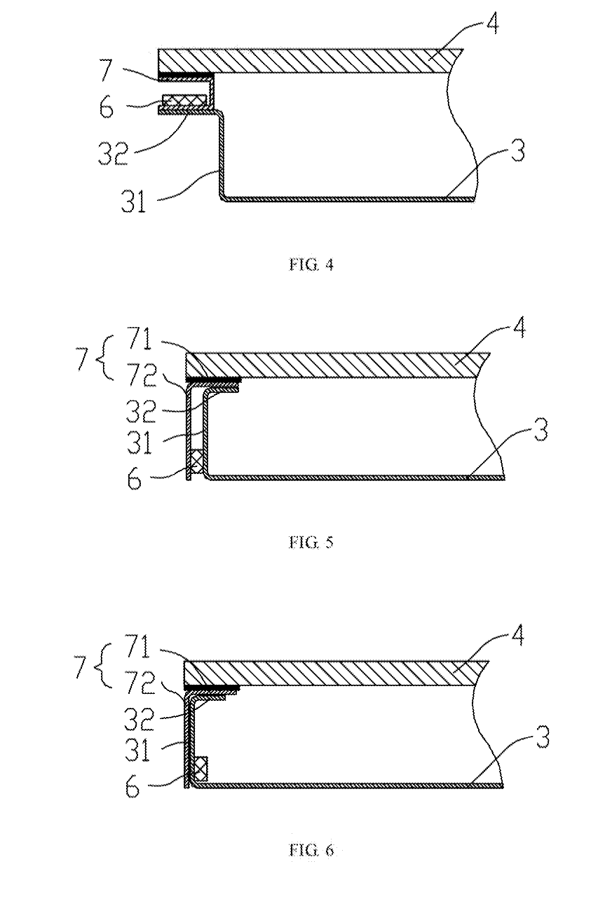

FIG. 4 shows a third example of the LCD module of the present disclosure, where the third example is different from the first example in that: the back of the LCD panel 4 is configured with an iron connecting piece 7, and the iron connecting piece 7 has a U-shaped cross section with an opening facing outwards. The backplane 3 is made of the ferromagnetic material, and the magnet 6 is arranged in the iron connecting piece 7 to enable the iron connecting piece 7 to be magnetically attractive. Thus, the iron connecting piece 7 is magnetically attached to the horizontal wall 32 of the backplane, to enable the LCD panel 4 to be oppositely fixed to the backplane 3.

In the example, because distance between the LCD panel 4 and the horizontal wall 32 of the backplane is controlled by the iron connecting piece 7, the magnet 6 only needs to provide sufficient attraction force. Thus, thickness of the magnet 6 can be reduced, and cost can be reduced.

FIG. 5 shows a fourth example of the LCD module of the present disclosure, and the fourth example is different from the third example in that: the sidewall 31 of the backplane 3 is bent inwards to from the horizontal wall 32, the LCD panel 4 is configured with an iron connecting piece 7 that has an L-shaped cross section, and comprises a first wall 71 and a second wall 72. An upper surface of the first wall 71 is connected with the back of the LCD panel 4, and a lower surface of the first wall 71 is abutted with the horizontal wall 32 of the backplane 3. The second wall 72 is arranged outside the sidewall 31 of the backplane 3. The magnet 6 is arranged between the second wall 72 and the sidewall 31 of the backplane, and magnetically attracted to the second wall 72 and the sidewall 31 of the backplane 7. Because the second wall 72 of the iron connecting piece 7 in the example is arranged outside the sidewall 31 of the backplane 3, and prevents dust from entering into the inside of the LCD module.

In the example, because the backplane 3 and the iron connecting piece 7 not exceedings the edge of the LCD panel 4, the LCD module has not frame at all. To improve dustproof effect, a sealing element is arranged between the first wall 71 of the iron connecting piece 7 and the horizontal wall 32 of the backplane 3.

In the example, when the backplane 3 is not configured with at horizontal wall 32, the lower surface of the first wall 71 is abutted with the sidewall 31 of the backplane, to support the LCD panel 4.

FIG. 6 shows a fifth example of the LCD module of the present disclosure, and the fifth example is different from the fourth example in that: the second wall 72 of the iron connecting piece 7 is arranged outside the sidewall 31 of the backplane 3 and is in contact with the sidewall 31 of the backplane 3, and the magnet 6 is arranged inside the sidewall 31 of the backplane 3, to enable the second wall 72 of the iron connecting piece 7 to be magnetically attracted to the sidewall 31 of the backplane. In the example, because the magnet 6 is arranged inside the backplane 3, a position of the magnet 6 is difficult to change and the magnet 6 is difficult to fall off. Other structures are consistent with structures of the fourth example, and the example Will not give unnecessary details.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A liquid crystal display (LCD) module, comprising:
an LCD panel and a backplane;
wherein the LCD panel is fixed to the backplane by a magnet; a back of the LCD panel is configured with an iron connecting piece, and the backplane is connected with the LCD panel from the back of the LCD panel; the backplane and the iron connecting piece not exceeding an edge of the LCD panel;
wherein the back plane comprises a sidewall, an upper edge of the sidewall of the backplane is configured with a horizontal wall that supports the LCD panel, and the sidewall of the backplane is bent outwards to form the horizontal wall;
wherein the LCD panel is configured with an iron connecting piece, and the iron connecting piece has a U-shaped cross section with an opening facing outwards; the backplane is made of a ferromagnetic material, the magnet is arranged in the iron connecting piece, and the iron connecting piece is magnetically attached to the horizontal wall of the backplane.

2. A liquid crystal display (LCD) module, comprising:
an LCD panel, and a backplane;
wherein the LCD panel is fixed to the backplane by a magnet.

3. The LCD module of claim 2, wherein a back of the LCD panel is configured with a magnet or an iron connecting piece, and the backplane is connected with the LCD panel from the back of the LCD panel; the backplane and the iron connecting piece not exceeding an edge of the LCD panel.

4. The LCD module of claim 2, wherein the backplane comprises a sidewall; an upper edge of the sidewall of the backplane is configured with a horizontal wall that supports the LCD panel.

5. The LCD module of claim 4, wherein the sidewall of the backplane is outwards bent to form the horizontal wall, or the sidewall of the backplane is inwards bent to form the horizontal wall.

6. The LCD module of claim 5, wherein the LCD panel is configured with a magnet, the backplane is made of a ferromagnetic material, and the magnet is magnetically attracted to the horizontal wall of the backplane.

7. The LCD module of claim 5, wherein the LCD panel is configured with a magnet, the horizontal wall of the backplane is configured with an iron connecting piece or a magnet, and the magnet of the LCD panel is magnetically attracted to the iron connecting piece or the magnet of the horizontal wall of the backplane.

8. The LCD module of claim 5, wherein the LCD panel is configured with an iron connecting piece, and the iron connecting piece has a U-shaped cross section with an opening facing outwards; the backplane is made of a ferromagnetic material, the magnet is arranged in the iron connecting piece, and the iron connecting piece is magnetically attached to the horizontal wall of the backplane.

9. The LCD module of claim 2, wherein the LCD panel is configured with an iron connecting piece; the iron connecting piece has an L-shaped cross section, and comprises a first wall and a second wall; the backplane comprises a sidewall; an upper surface of the first wall is connected with the LCD panel, and a lower surface of the first wall is abutted with the sidewall of the backplane; the second wall is arranged outside the sidewall of the backplane, and the magnet is arranged between and magnetically attached to the second wall and the sidewall of the backplane.

10. The LCD module of claim 2, wherein the LCD panel is configured with an iron connecting piece; the iron connecting piece has an L-shaped cross section, and comprises a first wall and a second wall; the backplane comprises a sidewall; an upper surface of the first wall is connected with the LCD panel, and a lower surface of the first wall is abutted with the sidewall of the backplane; the second wall is arranged outside the sidewall of the backplane and is in contact with the sidewall of the backplane, and the magnet is arranged inside the sidewall of the backplane, to enable the second wall of the iron connecting piece to be magnetically attracted to the sidewall of the backplane.

11. A liquid crystal display (LCD) device, comprising:
an LCD module that comprises an LCD panel and a backplane;
wherein the LCD panel is fixed to the backplane by a magnet.

12. The LCD device of claim 11, wherein a back of the LCD panel is configured with a magnet or an iron connecting piece, and the backplane is connected with the LCD panel from the back of the LCD panel; the backplane and the iron connecting piece not exceeding an edge of the LCD panel.

13. The LCD device of claim 11, wherein the backplane comprises a sidewall; an upper edge of the sidewall of the backplane is configured with a horizontal wall that supports the LCD panel.

14. The liquid crystal display (LCD) device of claim 13, wherein the sidewall of the backplane is outwards bent to form the horizontal wall, or the sidewall of the backplane is inwards bent to form the horizontal wall.

15. The LCD device of claim 14, wherein the LCD panel is configured with a magnet, the backplane is made of a ferromagnetic material, and the magnet is magnetically attracted to the horizontal wall of the backplane.

16. The LCD device of claim 14, wherein the LCD panel is configured with a magnet, the horizontal wall of the backplane is configured with an iron connecting piece or a magnet, and the magnet of the panel is magnetically attracted to the iron connecting piece or the magnet of the horizontal wall of the backplane.

17. The LCD device of claim 14, wherein the LCD panel is configured with an iron connecting piece, and the iron connecting piece has a U-shaped cross section with an opening facing outwards; the backplane is made of a ferromagnetic material, the magnet is arranged in the iron connecting piece, and the iron connecting piece is magnetically attached to the horizontal wall of the backplane.

18. The LCD device of claim 11, wherein the LCD panel is configured with an iron connecting piece; the iron connecting piece has an L-shaped cross section, and comprises a first wall and a second wall; the backplane comprises a sidewall; an upper surface of the first wall is connected with the LCD panel, and a lower surface of the first wall is abutted with the sidewall of the backplane; the second wall is arranged outside the sidewall of the backplane, and the magnet is arranged between and magnetically attached to the second wall and the sidewall of the backplane.

19. The LCD device of claim 11, wherein the LCD panel is configured with an iron connecting piece; the iron connecting piece has an L-shaped cross section, and comprises a first wall and a second wall; the backplane comprises a sidewall; an upper surface of the first wall is connected with the LCD panel, and a lower surface of the first wall is abutted with the sidewall of the backplane; the second wall is arranged outside the sidewall of the backplane and is in contact with the sidewall of the backplane, and the magnet is arranged inside the sidewall of the backplane, to enable the second wall of the iron connecting piece to be magnetically attached to the sidewall of the backplane.
